(19) United States
(12) Patent Application Publication
(10) Pub. No.: US 2004/0121264 A1
(43) Pub. Date: Jun. 24, 2004

(54) Pattern transfer in device fabrication

(76) Inventors: Bernhard Liegl, Cold Spring, NY (US); Juergen Preuninger, Wappinger Falls, NY (US); Larry Varnerin, Pleasant Valley, NY (US); Gary Williams, Fishkill, NY (US); Enio Carpi, Fishkill, NY (US); Xiaochun L. Chen, Mechanicsville, VA (US)

Correspondence Address: SLATER & MATSIL, L.L.P., 17950 PRESTON RD, SUITE 1000, DALLAS, TX, 75252-5793, US

(21) Appl. No.: 10/065,956

(22) Filed: Dec. 4, 2002

(51) Int. Cl. G03C 5/00

(52) U.S. Cl. 430/311; 430/322; 430/330

(57) ABSTRACT

A method of transferring a pattern onto a substrate during IC fabrication is disclosed. The substrate is coated with a photosensitive layer having compounds dissolved in a solvent. Roughness on the sidewalls of the photosensitive layer is eliminated or reduced by evaporating the solvent without using elevated temperatures.

### BACKGROUND OF INVENTION

The fabrication of integrated circuits (ICs) involves the formation of features that make up devices, such as transistors and capacitors, and the interconnection of such devices to achieve a desired electrical function. Since the cost of fabricating ICs is inversely related to the number of ICs per wafer, there is a continued demand to produce a greater number of ICs per wafer. This requires features to be formed smaller and smaller to reduce manufacturing costs.

Photolithographic techniques are used to form features on the substrate. Such techniques include the use of a photoresist mask formed on a substrate. The photoresist mask contains the desired pattern to create the features on the substrate. The photoresist mask is formed by depositing a photoresist layer 120 on a substrate 110, as shown in FIG. 1. The photoresist layer typically contains photoactive compounds (PAC) which are photo-acid generators. The acid can, for example, catalyze a chemical reaction in the resist when exposed to light. The chemical reaction changes the resist solubility, enabling exposed or unexposed portions to be removed by a developer.

Typically, photoresist compounds are dissolved in a solvent and applied onto the substrate by spin-on techniques. A post-application soft bake is performed, for example, at a temperature of 70-150 degrees Celsius for about 1-30 minutes to remove the solvent. The resist is then exposed with radiation or light through a mask 140 having the desired pattern.

FIG. 2 shows cross-sectional and top views of a substrate 110 with a resist layer 120. The resist is developed to remove either the exposed or unexposed portions, depending on whether a positive or negative tone resist is used. This creates an opening 225 in the resist layer, exposing the substrate below. An etch process patterns the substrate using the resist layer as an etch mask, creating the desired features. In some types of photoresist, excessive roughness can be observed on the edges 245 of the resist (referred to as line edge roughness or LER). LER can distort the resist mask, adversely impacting the transfer of the desired pattern onto the substrate. This reduces the lithographic process window. As feature size becomes smaller, the irregular pattern transfer can cause various device issues, particularly with patterns of high resolutions in, for example, memory ICs. For example, irregular pattern transfer can cause variations in transistor gate threshold voltage (V_{T}), leakage, and degradation of retention time, thereby adversely impacting device performance, reliability, and manufacturing yields.

From the foregoing discussion, it is desirable to reduce LER in the resist to improve the transfer of patterns from the resist to the substrate.

### SUMMARY OF INVENTION

The present invention relates to the fabrication of ICs. More particularly, the invention relates to the transfer of patterns on a substrate for forming features during IC fabrication. The substrate is coated with a photosensitive layer having compounds dissolved in a solvent. In accordance with the invention, the solvent is evaporated without using elevated temperatures to reduce or eliminate roughness exhibited on the sidewalls of the photosensitive layer after development. In one embodiment, the solvent is evaporated in a vacuum environment.

### BRIEF DESCRIPTION OF DRAWINGS

FIGS. 1-2 show a conventional process for forming a photosensitive mask; and

FIGS. 3-4 show a process for forming a photosensitive mask in accordance with one embodiment of the invention.

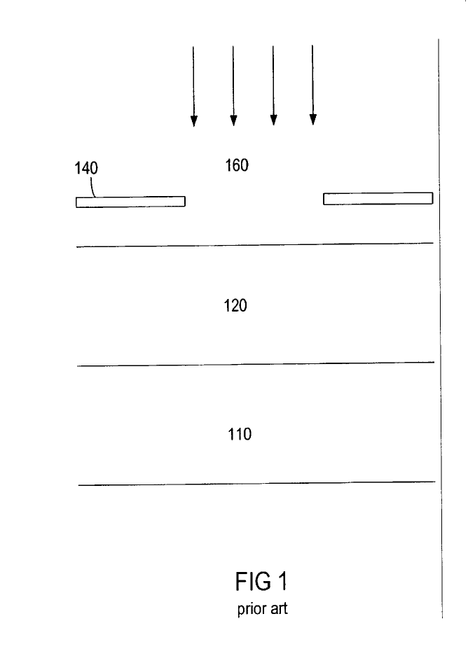

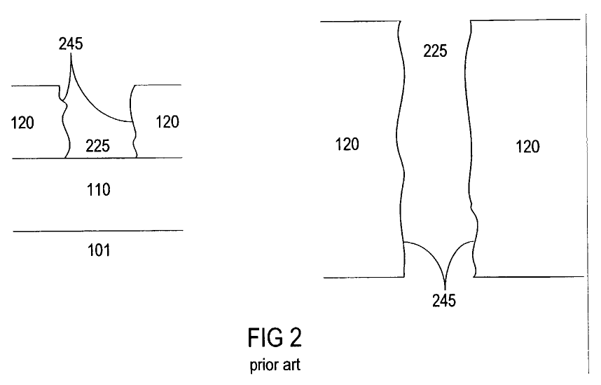

### DETAILED DESCRIPTION

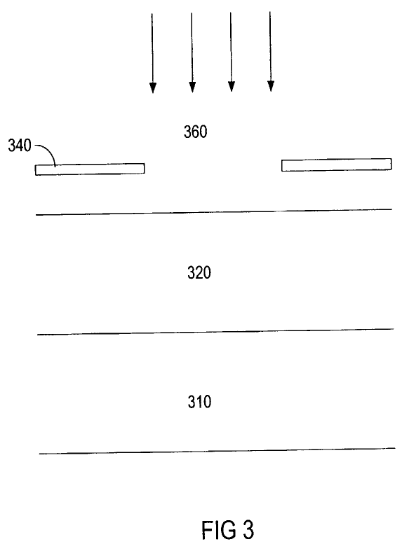

FIG. 3 shows a process for forming a photosensitive mask on a substrate. The photosensitive mask can be used to create features on the substrate during, for example, IC fabrication. Various types of ICs, such as memory, processors or DSPs, can be formed. As shown, a substrate 310 is provided. The substrate, in one embodiment, is a semiconductor substrate, such as silicon. The substrate can be prepared to include one or more device layers, depending on the stage of processing. For example, device layers can include dielectric materials (e.g., silicon dioxide or silicon nitride), conductive materials (copper, tungsten, or aluminum), or semiconductive materials (polysilicon). In some cases, the substrate itself can be patterned to create, for example, trenches for capacitors or isolation.

A photosensitive layer 320 is deposited on the surface of the substrate. In one embodiment, the photosensitive layer comprises photoresist. Various types of photoresist, such as positive or negative tone photoresist, can be used. The photoresist comprises components, such as photosensitive compounds, which are dissolved in a solvent. In one embodiment, the photoresist is sensitive to radiation wavelengths at or below 193 nm. Photosensitive materials that are sensitive to radiation at other wavelengths are also useful. The photosensitive layer is deposited on the substrate by spin-coating techniques. Spin-coating is achieved by spinning the substrate at high speeds, for example, 1000 to 5000 rpm for about 30 to 60 seconds.

Variations of light or reflectance into the resist layer can occur. To reduce variations of reflectance, an antireflective coating (ARC) can be deposited on the substrate prior to depositing the photoresist layer. Various types of ARC can be used.

The ARC comprises, for example, an organic material such as the AZ® BARLi® -II coating material manufactured by Clariant AG. Non-organic materials with suitable optical properties, such as titanium nitride (TiN) or silicon carbide (SiₓO_{y}C_{z}), are also useful.

In conventional processes, a soft bake is performed after being deposited on the substrate to evaporate the solvent. The resist is heated to above the boiling point of the solvent at ambient pressure to ensure its complete evaporation. Typically, the soft bake is performed at an elevated temperature of about 70 to 150 degrees Celsius. It has been found that elevated baking temperatures can induce changes in the physical and chemical properties of the resist. This can lead to significant LER, which adversely affects the lithographic window.

In accordance with the invention, the solvent of the resist layer is evaporated without using elevated temperatures. The solvent is removed by reducing the pressure of the environment, which causes the boiling point of the solvent to drop. A low pressure or vacuum environment accelerates the evaporation of the solvent without the use of elevated baking temperatures. The pressure of the environment can be, for example, about 1 Pa to less than 1×10⁵ Pa. For example, a moderate vacuum pressure of less than 10 hPa can be used to evaporate the solvent of a thin layer of resist comprising a thickness of 1 μm or less at about room temperature. The solvent comprises, for example, propylene glycol monomethyl ether acetate (PGMEA), ethylacetate or cyclohexanol. Other types of solvents are also useful. Evaporation is accelerated without the use of elevated baking temperatures, which may induce changes in the mechanical or chemical properties of the photosensitive materials. In one embodiment, temperatures raised slightly above room temperature may also be used in combination with the vacuum environment to accelerate the evaporation process. Different combinations of temperature and vacuum conditions may be provided, depending on the type of solvent used and its associated boiling behavior.

Elevated baking temperatures used in conventional processes, for example, increases the rate of phase separation, which introduces LER in the resist. By eliminating the elevated temperatures, thermally induced changes can be avoided or minimized. In addition, the use of vacuum conditions accelerates the processing time. Hence, the rate of phase separation is less significant with respect to the processing time scale, and this effectively reduces or eliminates LER, which has been observed in conventional resist processes.

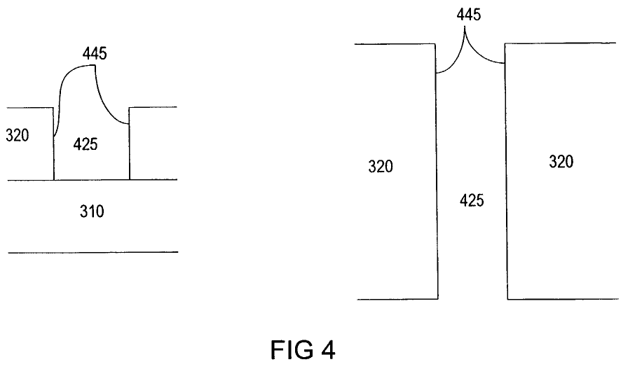

After the solvent is evaporated from the resist, the process continues as in conventional lithographic processes. For example, the resist is selectively exposed with radiation through a mask with the desired patterns. As shown in FIG. 4, the resist is developed to remove either the exposed or unexposed portions 425, depending on whether a positive or negative tone resist is used. The patterned resist layer serves as a mask for a subsequent etch process to create the desired features on the substrate. Since thermally induced changes are avoided, the edges of the resist 445 are not rough, thereby improving pattern transfer to the substrate.

While the invention has been particularly shown and described with reference to various embodiments, it will be recognized by those skilled in the art that modifications and changes may be made to the present invention without departing from the spirit and scope thereof. The scope of the invention should therefore be determined not with reference to the above description but with reference to the appended claims along with their full scope of equivalents.

1. A method of pattern transfer in the fabrication of ICs, comprising:
providing a substrate;
coating the substrate with a photosensitive layer having compounds dissolved in a solvent;
evaporating the solvent from the photosensitive layer without using elevated temperatures;
selectively exposing the photosensitive layer; and
developing the photosensitive layer to selectively remove portions thereof, wherein evaporating the solvent without using elevated temperatures reduces roughness on sidewalls of the photosensitive layer after development.

2. The method of claim 1 wherein the photosensitive layer comprises photoresist.

3. The method of claim 2 further comprises the step of providing an antireflective coating on the substrate.

4. The method of claim 3 wherein the step of coating the substrate with a photosensitive layer comprises spin-coating techniques.

5. The method of claim 2 wherein the step of coating the substrate with a photosensitive layer comprises spin-coating techniques.

6. The method of claim 1 wherein the step of coating the substrate with a photosensitive layer comprises spin-coating techniques.

7. The method of claim 6 further comprises the step of providing an antireflective coating on the substrate.

8. The method of claim 1 further comprises the step of providing an antireflective coating on the substrate.

9. The method of claim 1 wherein the step of evaporating the solvent comprises evaporating the solvent in a vacuum environment.

10. The method of claim 9 wherein the step of evaporating the solvent further comprises evaporating the solvent at about room temperature.

11. The method of claim 9 wherein the step of evaporating the solvent further comprises evaporating the solvent at temperatures raised slightly above room temperature.

12. The method of claim 9 wherein the vacuum environment comprises a pressure of about 1 Pa to less than 1×10⁵ Pa.

13. The method of claim 12 wherein the step of evaporating the solvent further comprises evaporating the solvent at about room temperature.

14. The method of claim 12 wherein the step of evaporating the solvent further comprises evaporating the solvent at temperatures raised slightly above room temperature.

15. The method of claim 9 wherein the pressure is less than 10 hPa.

16. The method of claim 15 wherein the step of evaporating the solvent further comprises evaporating the solvent at about room temperature.

17. The method of claim 15 wherein the step of evaporating the solvent further comprises evaporating the solvent at temperatures raised slightly above room temperature.

18. The method of claim 1 wherein the step of evaporating the solvent further comprises evaporating the solvent at about room temperature.

19. The method of claim 1 wherein the step of evaporating the solvent further comprises evaporating the solvent at temperatures raised slightly above room temperature.

20. A method of pattern transfer in the fabrication of ICs, comprising:
providing a substrate;
coating the substrate with a photosensitive layer having compounds dissolved in a solvent;
evaporating the solvent from the photosensitive layer in a vacuum environment without using elevated temperatures;
selectively exposing the photosensitive layer; and
developing the photosensitive layer to selectively remove portions thereof, wherein evaporating the solvent without using elevated temperatures reduces roughness on sidewalls of the photosensitive layer after development.

21. A method of pattern transfer in the fabrication of ICs, comprising:
providing a substrate;
coating the substrate with a photoresist layer having compounds dissolved in a solvent;
evaporating the solvent from the photoresist layer in a vacuum environment without using elevated temperatures;
selectively exposing the photoresist layer; and
developing the photoresist layer to selectively remove portions thereof, wherein evaporating the solvent without using elevated temperatures reduces roughness on sidewalls of the photoresist layer after development.
